(19) United States
(12) Patent Application Publication
(10) Pub. No.: US 2014/0338210 A1
(43) Pub. Date: Nov. 20, 2014

(54) METHOD AND APPARATUS FOR SANITARILY REMOVING SWEAT AND PROTECTING AND CARRYING PERSONAL ITEMS

(71) Applicant: Reginald L. Young, Surprise, AZ (US)

(72) Inventor: Reginald L. Young, Surprise, AZ (US)

(21) Appl. No.: 13/894,479

(22) Filed: May 15, 2013

(51) Int. Cl. B32B 5/26

(52) U.S. Cl. CPC B32B 5/26
USPC 34/95; 156/292

(57) ABSTRACT

The present invention includes a plurality of layered materials used to facilitate the removal of sweat and toxins which a person may experience during a physical workout. It is useful for sanitarily wicking away sweat and various other functions which may be specific to a person's needs such as carrying important items.

### FIELD OF INVENTION

The present invention is related to towels used for sporting events by athletes or persons participating in physical activities; and more particularly to an apparatus which is useful for sanitarily wicking away sweat and carrying important items in a compartment which is water and heat resistant.

### BACKGROUND OF INVENTION

There are several towels on the market which are used by athletes during for sporting events or by gym goers while they exercise. Some of the producers of these towels are Wilson®, Under Armour®, etc. However, none of the current towels include a novel way for carrying personal belongings within a towel that sanitarily wicks away sweat. Furthermore, none of the current towels allow for a user's personal belongings to be stored within the towel via a heat and water resistant compartment.

As one example, the football towel sold by Under Armour®, discloses a football towel made with anti-microbial 100% polyester. Although this football towel provides a means for sanitarily removing sweat, it fails to teach a compartment within the towel for protecting and carrying personal items. The Under Armour® towel also fails to teach a specific layering of multiple materials to aid in the towel's anti-microbial and drying abilities.

In yet another example, the football towel sold by Wilson®, discloses a football towel made of terry cloth to absorb sweat. However, this towel fails to provide a sanitary means for wicking away sweat or a means for protecting and carrying personal items.

In another example, U.S. Pat. No. 4,224,712, hereinafter referred to as Black discloses a towel used to remove sweat. Although Black discloses a towel to remove sweat and a method for producing said towel, Black fails to disclose a means for carrying and protecting personal belongings within the towel itself.

In summary, none of the aforementioned items either exclusively, or in conjunction with each other, teach a novel way for carrying and protecting personal belongings within a towel that sanitarily wicks away sweat and dries quickly to prevent the spread of disease.

### SUMMARY OF INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

To resolve the problems mentioned above, an object of the present invention is to provide a sanitary means for removing perspiration. With personal healthcare becoming a more prevalent issue, more people are beginning to participate in physical activities and workout sessions. Some of these physical activities and workout sessions include, but are not limited to, running, cycling, jogging, sports, weightlifting, etc.

The general practice for removing excess perspiration during a workout is for a person to blot their skin with a clean dry towel and avoid rubbing and wiping their skin with their hands. As such, it is of utmost importance to undertake a sanitary workout regimen during and after each workout session so as not to contract or transfer certain communicable diseases from or to other workout goers. Some of these communicable diseases include, but are not limited to ringworm, herpes, and methicillin-resistant Staphylococcus aureus (MRSA), which are highly contagious among both athletes and average exercisers, according to the American Academy of Dermatology. It is also important to protect your face against acne during and after workout sessions. Although perspiring during workout sessions removes toxins from the body and can help to rid acne, it is important not to transfer oil and bacteria, which thrive in humid gym environments, to your skin. Therefore, it is important to ensure that the towels which gym goers and athletes use are sanitary and tend to rid rather than retain bacteria.

The current industry standard makes use of cotton towels; however, cotton tends to absorb moisture but the toxins from the perspiration remain on the surface of the cotton towel. Persons using cotton towels to continuously remove moisture from their skin are re-contaminating their skin with the toxins they removed previously. Therefore, it is an object of this invention to prevent recontamination and prevent a person's skin from drying out. Consequently, there is still an unmet need in the field to continuously and sanitarily remove perspiration from a person during their workout sessions.

It is another object of the present invention to provide a convenient method for carrying personal items during a person's workout session. Although workout sessions generally include persons ridding their body of any personal belongings that could restrict, prohibit, or confine their workout session, it is still important for persons to keep important personal belongings on their person. For instance, people who run long distances outdoors will need to keep certain items on their person including, but not limited to: keys to get back into their vehicle or house, identification for emergency purposes, cash or credit cards for purchases along their route, and/or mobile phones for communication purposes. The aforementioned items are generally standard for most runners or anyone working out outdoors. Therefore, there is an unmet need in the field for a person to be able to conveniently carry these items in one location during their workout without fear of loss of the items or the items inhibiting their workout.

Finally, the present invention may be used to protect the aforementioned personal items during the workout session and thereafter. Because people generally perspire excessively during their workout sessions, it is important to protect these personal items from the moisture of their perspiration. It is also important to protect these items from moisture and heat should they accidentally be left in the user's workout gear and placed in the washing machine or dryer. Therefore, there is still an unmet need to protect these items in case of accidental washing or drying.

Still other objects of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawings and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is an exploded view of the towel showing its several layers.

FIG. 2 is cut-away view of the towel showing its several layers.

FIG. 3 is a perspective view of the towel showing its attachment means and pocket.

FIG. 4 is a front view of the towel showing its attachment means and a mouthpiece pocket.

FIG. 5 is a side view of the towel showing the mouthpiece pocket and the guide-piece.

FIG. 6 is a perspective view of the towel showing the mouthpiece pocket on top of the attachment/detachment means.

FIG. 7. is a perspective view of the towel showing a hand pocket on top of the mouthpiece pocket.

FIG. 8. is a front view of the towel showing pocket for golf balls and tee holders for golf tees.

FIG. 9. s a front view of the towel showing dart holders for darts.

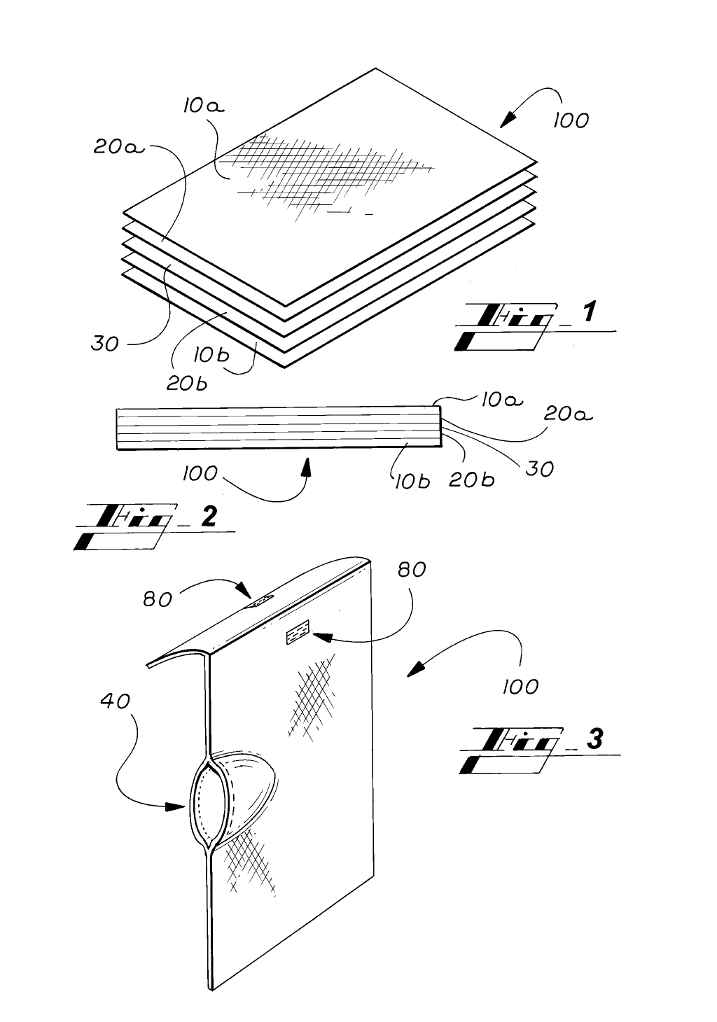

### DETAILED DESCRIPTION

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

The towel comprises several layers of various materials in order to facilitate the wicking of sweat in a manner which is sanitary and prevents some moisture from being absorbed into the towel. Such materials may include, but are not limited to, polyester, nylon birdseye, terry, or lycra. Anti-microbial fabric may also be used to help prevent odor before it occurs. The layering of these materials, based upon their specific individual characteristics and in conjunction with each other, create useful elements of the current invention. Furthermore, any layer of the towel may contain naturally occurring moisturizing agents to replenish a person's natural oils which are lost as they perspire during a workout. Such moisturizing agents may include beneficial ingredients such as, but not limited to, grape seed oil, naturally occurring skin lipids, anti-oxidants, alpha hydroxyl acids, chamomile, or aloe. These moisturizing agents will help to replenish the moisture lost during a workout, thus reducing the need for man-made moisturizers upon completion of the workout.

In one embodiment the outermost layers 10a and 10b of the towel consist of polyester, or polyester like material. The top outermost layer 10a and the bottom outermost layer 10b form the external surface of the towel. Polyester fabrics can provide specific advantages over natural fabrics, such as improved wrinkle resistance, durability and high color retention. As a result, polyester fibers are sometimes spun together with natural fibers to produce a cloth with blended properties. Synthetic fibers also can create materials with superior water, wind and environmental resistance compared to plant-derived fibers.

The inner layers 20a and 20b are composed of nylon or nylon like material. The top inner layer 20a and the bottom inner layer 20b are in direct contact with the outermost layers 10a and 10b. There are various commercialized types of nylons or polyamide fusible webs which permanently bond two layers of fabric together or work as a stabilizer. For use in this application, such nylons include but are not limited to, Stitch Witchery, Wundaweb, Heat'n bond, Stitch'n Sew, etc.

Nylon is a generic designation for a family of synthetic polymers known generically as polyamides, which have highly resilient characteristics because they are heat-set causing nylon to melt instead of burning in high temperature situations. Nylons are also highly resistant to insects, fungi, animals, as well as molds, mildew, rot and many chemicals. Although it is commonly used to manufacture outdoor and workout clothing, it has the feel of soft cotton, yet unlike cotton, it is waterproof and breathable, which helps it maintain a comfortable temperature and wick away moisture. Yet another added benefit of nylon is that it removes dirt, stains, and body oils and is machine washable. This is a smooth surfaced fiber material that has a cross section that is almost circular. This fabric also has a very high abrasion resistance, along with a thermal conductivity that it very low when compared to other materials. The aforementioned characteristics of nylon make it an ideal choice for the composition of inventive idea.

Polyester and nylon are both lightweight and durable synthetic fabrics that share many of the same properties, such as easy care, wrinkle resistance, stretch resistance and shrink resistance. All of these qualities lend to the utility of the inventive idea. Nylon is softer and stronger than polyester; however polyester dries faster than nylon. Both are naturally hydrophobic, which mean they expel water, ideally to the surface of the towel where it will evaporate. Nylon actually absorbs some water, which means it takes longer for a wet garment to dry. However, because polyester, which is the outermost layer is faster drying, this allows the outside of the towel to dry quickly so that the nylon layer of the towel can breathe enough to reduce mold and germs from perspiration.

The nylon or nylon like layer is in contact with an innermost layer 30 comprising a cotton or cotton-like material suitable to absorb residual moisture. Birdseye diaper cloth is particularly useful, as the innermost material, for this combination because of its inherent absorbent quick-drying characteristics. Cotton birdseye weave is made of one hundred percent cotton fabric and is woven from small, fine yams in a way that results in a soft, quick drying, absorbent diaper. Because it is made from cotton, it is easy to wash and reuse and does not require the special care that some of the other fabrics require.

As discussed earlier, the towel may be layered in various ways to facilitate the removal of toxins and replenishment of moisture; and although it is not possible to describe every different combination, we will describe another useful embodiment to further describe the invention.

In another embodiment, the towel may be reinforced with an extra polyester or polyester like layer at the center of the towel. Therefore, the layering may occur as follows: polyester, nylon, cotton, polyester, cotton, nylon, polyester; or polyester, nylon, cotton, nylon polyester, nylon, cotton, nylon, polyester.

The first useful element of this invention is the ability to wick away moisture as a person uses the invention to rid themselves of sweat or moisture. The polyester fibers are used in this invention as a first line of defense against absorption of moisture or perspiration, Moisture which is not wicked away is allowed to pass through to the polyester layer. However, because of the nylon layers quick drying properties, the polyester layer also dries quickly. Residual moisture is then absorbed by the innermost cotton layer; the combination of these fabrics in a specific order allow for an overall breathable towel which facilitates the drying of moisture and reduction of germs and disease. At the same time, moisturizing agents, which may be placed on any layer of the towel, are replenishing some of the moisture lost as a person wipes with the towel.

In yet another embodiment, as shown in FIG. 3, the towel includes a pocket 40 used for carrying items such as keys, credit cards, cash, mobile devices, etc. This pocket 40 may be made out of any heat resistant and/or waterproof materials to prevent personal belongings from being ruined or destroyed by perspiration or if they are inadvertently placed in the washing machine or dryer. The pocket 40 will also prevent damage to the contents therein from inclement weather or less than ideal conditions. The inner lining of the pocket 40 may consist of separate or any combination of materials, including but not limited to, Nomex®, Kevlar®, foil, coated nylon, polyurethane, polyvinyl chloride, silicon elastomer. Any given towel may have more than one pocket 40. Each pocket 40 may also have a heat and/or water resistant means for sealing and securing its contents, including but not limited to, zippers, pressable sealers as found on Ziploc® bags, fasteners, etc.

Because a person may want to utilize their mobile device within the pocket 40 of the towel, the pocket 40 may also contain transparent material and/or a re-sealable headphone jack opening. The purpose of the headphone jack opening being re-sealable is because there has to be an opening for the headphone wire to be inserted through the pocket while in use, therefore the user needs to be able to close this opening when not in use to prevent water or heat damage should the mobile device be accidentally left in the pocket during washing or drying processes. Therefore, the only time the headphone jack opening would be open, is during use of the headphones.

The towel will also have a fastening means 80 for removably attaching and detaching to/from a person. Such means may comprise, but are not limited to; a belt, a clip and grommet, Velcro®, or buttons. These means will allow a person to quickly attach or remove the towel from his person.

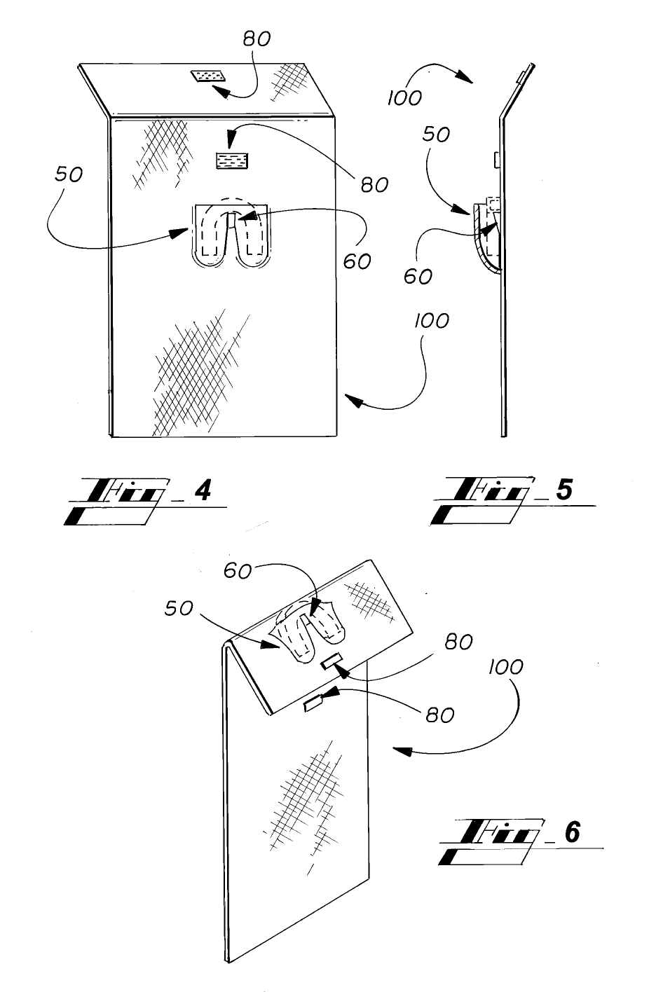

In yet another embodiment, shown in FIGS. 4,5, and 6, the towel may include a mouthpiece pocket 50 in the shape of a mouthpiece such as those worn by football players. This pocket may also consist of a guide-piece 60, which will allow for the mouthpiece to be properly aligned within the mouthpiece pocket 50. The guide-piece 60 may be made of a variety of materials including but not limited to plastics or fabrics, which will facilitate the placement and removal of the mouthpiece during use of the towel. Furthermore, the guide-piece 60 will prevent the mouthpiece from being inserted incorrectly into the mouthpiece pocket 50.

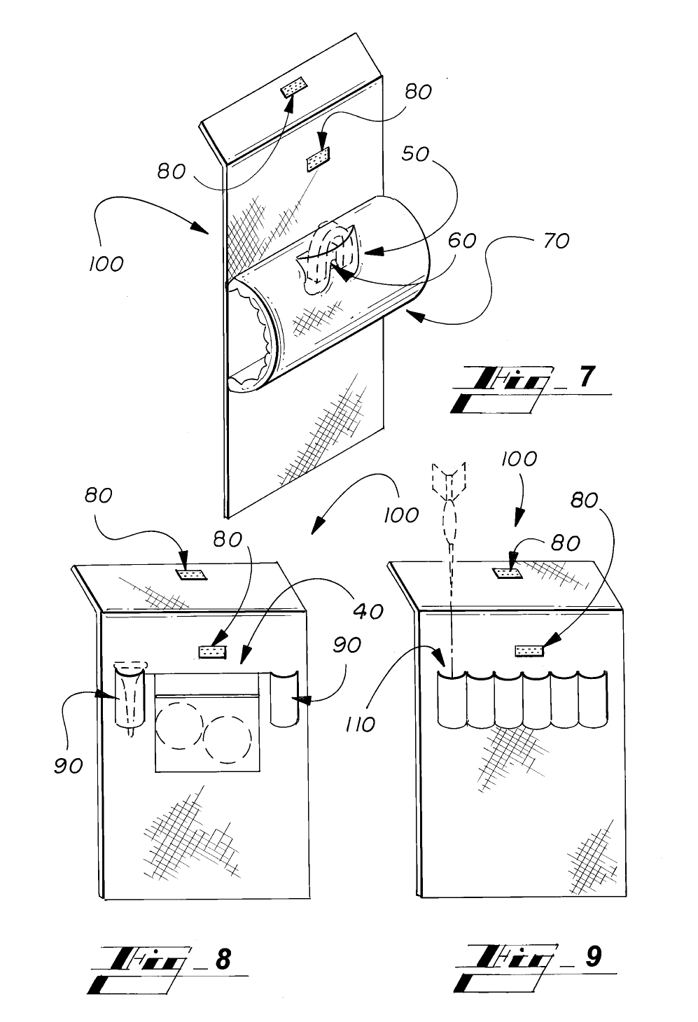

In a further embodiment, shown in FIG. 7, an additional a layer may be added for hand pocket 70, which has openings on both sides. Hand pocket 70 may be placed under the mouthpiece pocket 50 in order to facilitate the hands of a person using the towel being, placed within the hand pocket 70. This hand pocket 70 may be so dimensioned as to hold a hot pocket for use by football players or others during the winter season.

In another embodiment, as shown in FIG. 8, the towel may contain a pocket 40 so dimensioned to hold a plurality of golf balls. The towel may also have tee holders 90 which are used to hold golf tees and/or divot removers. The towel itself will allow a golfer to remove sweat from his hands before grabbing a golf ball and tee to set up for swing. The golfer will also have the ability to utilize the towel to wipe his hands before each swing so that he maintains a firm grip on the club throughout his swing.

In an alternate embodiment, as shown in FIG. 9, the towel may contain a plurality of dart holders 110. The dart holders 110 are used to facilitate easy access to the darts placed therein during a game of darts. The towel itself, will allow a person to easily remove sweat from their hands before grasping a dart to be thrown thereby improving the accuracy of the dart players throw.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A towel for wicking away moisture comprising: a plurality of layered materials in the order of: polyester, nylon, cotton, nylon, and polyester.

2. The towel of claim 1, wherein the polyester layers contains a moisturizing agent.

3. The towel of claim 1, comprising a pocket.

4. The pocket of claim 3, comprising a re-sealable recess for a headphone jack.

5. The towel of claim 1, comprising a mouthpiece pocket.

6. The mouthpiece pocket of claim 5, comprising a guide-piece.

7. The mouthpiece pocket of claim 4, layered over a hand pocket.

8. The towel of claim 1, comprising a means for attaching and detaching the towel to the body.

9. The towel of claim 1, comprising a pocket and golf tee holders.

10. The towel of claim 1, comprising dart holders.

11. The pocket of claim 3, comprising ate resistant and heat resistant material.

12. The pocket of claim 3, comprising a heat resistant material.

13. The pocket of claim 3, comprising a plastic seal.

14. The pocket of claim 3, comprising a zipper.

15. The pocket of claim 3, comprising a transparent material.

16. A method for creating a towel for wicking away moisture comprising: layering materials in the order of polyester, nylon, cotton, nylon, and polyester; and applying heat to seal the materials.

17. The method of claim 16, comprising the formation of a pocket on the polyester layer.

18. The method of claim 16, comprising the formation of a mouthpiece pocket on the polyester layer.

19. The method of claim 16, wherein a guide-piece is attached to the inside of the mouthpiece pocket.

20. The pocket of claim 17, wherein a transparent material is attached to form the exterior of the pocket.
